(19) United States
(12) Patent Application Publication
(10) Pub. No.: US 2002/0171299 A1
(43) Pub. Date: Nov. 21, 2002

(54) Sink electricity, generation,computers on three digit (0,1,2), operation of machinery

(76) Inventor: Hanna Albert Awad, Sterling Heights, MI (US)

Correspondence Address: Hanna Albert Awad, Ajaltown, Kesrowan, LB

(21) Appl. No.: 09/886,221

(22) Filed: Jun. 21, 2001

Related U.S. Application Data
(60) Provisional application No. 60/291,913, filed on May 19, 2001.

(51) Int. Cl. H02P 9/04

(52) U.S. Cl. 307/149

(57) ABSTRACT

Sink Electricity is the decrease of motion of electrons and their transmission which is the opposite of electricity.

A generator of sink electricity is the opposite of ordinary generator. Sink Current is withdrawn from the free moving rotor and the power is put on the stator to turn it.

Operation of computers on three digit arithmetics (0,1,2) .current is used both ways, by using normal electricity and sink electricity. Applications on electronic ships, microelecronics, telecommunications and satellite dishes.

Operation of machinery on both sink electricity and normal electricity (current doubled, voltage double) On motors (torque increased, RPM increased).

Use of three, four, five, etc. . . . phase electricity (Y and delta) on both sink electricity and normal electricity.

### CIRCUMSTANCES AND DATE OF CONCEPTION

In August, 2000—I was in Lebanon and I thought why can we generate low temperatures and high temperatures and we can only generate high motion of electrons. By analogy, I thought that electrons moves, either we can increase their move or decrease their move which is sink electricity. In one week, I figured out how to generate sink electricity, how to operate computers on three digit (0,1,2) or (sink ON, OFF, ON) instead of (0,1) OR (ON,OFF), how to operate machinery especially motors on (phase, neutral, sink phase).

### DESCRIPTION OF THE INVENTION

If you increase the motion of electrons, you will have electricity and then it would be transmitted. So, what if you decrease the motion of electrons and transmit that decrease, you will have sink electricity.

From this sink electricity you can make resistances that cools, you can use three phase sink electricity Or four phases, five, six phases, etc. . . . in a four phase you will have connections like pyramid (for delta) And four connections to a neutral (for Y), in a five phase you will have a pyramid and a fifth end Connected to the four ends of the pyramid (for delta), and a five connections to a neutral (for Y), Etc. . . . So, you will be multiplying voltage or current by square root of 3,4,5,6 etc. . . . This is used if larger voltages or currents are needed in electricity or sink electricity and applying that to generators, motors, machinery.

So, sink electricity could be used for resistances, capacitors, inductances, known and unknown machinery and circuits. You can combine both sink electricity and normal electricity to have a voltage drop doubled. You will have sink current, sink voltage, and sink power. You can create IC's and electronic circuits and components and networks based on this sink electricity.

Generation of Sink Electricity:

it is the same as a normal generator but everything is reversed. The stator turns. You will have a free motion of the rotor to dump electricity (or motion of electrons) And a sink current could be withdrawn from the rotor and generated.

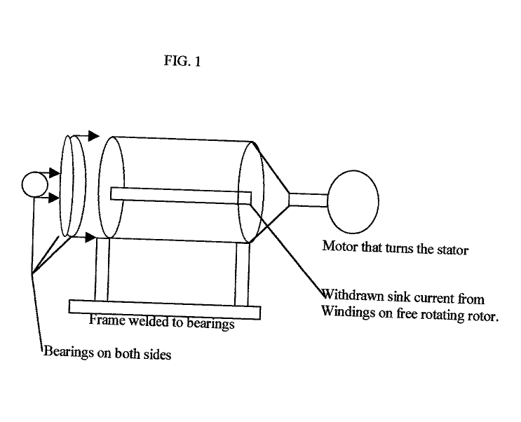

A sink current is needed on the windings of the stator in rotation to make the system works. So, a part of the sink current generated on the rotor is taken by brushes to brushes on the stator and put on the windings of the stator in motion. And you will have a free rotation of the rotor to dump electricity (or motion of electrons). And a sink current is generated from the rotor. (FIG. 1)

Computers operating on (0,1,2) or (sink electricity ON, OFF, ON): instead of having a two arithmetic digit you will have a three arithmetic digit (example: 5 instead of being 101 in two digit arithmetics, it will be 12 in three digit arithmetics.

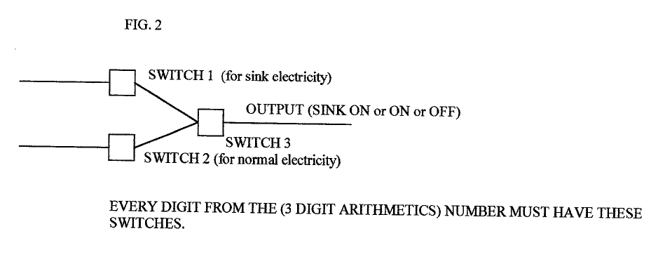

For every digit you must have three switches: Switch1 for sink electricity, switch2 for normal electricity, And switch3 will have as input the two outputs of the switch 1 and 2 and an output which could be (0,1,2) or (sink ON, normal ON, OFF). Switch3 will prevent the (sink ON, normal ON) condition. Switches are the simplification of electronic components (FIG. 2).

Operation of Machinery:

especially motors which will have sink current on the rotor windings and electricity current on the stator windings (increase of output (rpm and torque) by at least 500%). Instead of having (phase and neutral) you will have (sink phase, phase, neutral) which will operate Machinery. A three phase or four phase or more could be used as described above. Three or four or five or more phases (delta and Y) systems could be applied on normal electricity.

### PURPOSE

It is a new field. First how to generate sink electricity to make cooling resistances possible, circuits that increase output tremendously, motors that have their output increased significantly, new field in machinery, electronics and circuits. In computers the purpose is clear, a three digit will give a 3 to 2 better performance. Computers more compact. New electronic gates could be generated (other than (and, or)) example: a gate that has three inputs and one output If the three inputs are the same you can have 0 output, if two are the same you can have 1 as output, and if the three are different you can have 2 as output. More complex, more efficient, larger and more compact memories, faster computers.

Parts:

For the generator, bearings should be used on the inside and outside of the rotating stator and for both ends, and for the two ends of the rotor. All bearings should be welded to a fixed frame. Brushes should be used for the rotating stator and rotor to transmit sink electricity to the windings. A battery of sink electricity must be used to feed the rotating winding of the stator for the start of rotation, after that it will be fed by the output from rotor.

For the computer, IC's should be designed and manufactured. To start with, ordinary tiny switches could do the job.

Use:

How to use the generator is by feeding the windings of the rotating stator by sink current from a battery (for the start only) then turning the stator which results in a free rotation of the rotor and the generation of sink current from the rotor (part of it will feed the stator replacing the battery). A current is withdrawn from the free rotating rotor to feed the circuits in question.

For the computer, for every digit you will have three switches or IC's as explained above. And for other parts and how to use the computer, it is the same as ordinary computers.

Novel Features:

It is a new field by itself. I never heard or red or met anything like it I have computer engineers as friends that works in latest technologies, they never heard of something like that About generation of sink electricity, I am a mechanical engineer and I know that there has never been something like it in the new technologies.

Advantages:

better output for machinery, cooling resistances, other hidden circuits and uses and for computer usage. for computers, faster computers, more compact sizes of memories and much more capacities, quicker performance, you can deal with 3 digit arithmetics instead of 2 digit arithmetics in computing and storing and size of numbers.

Testing Results:

I have transformed a small generator to a sink electricity generator, by putting bearings and add brushes to the rotating stator and welding the stator end to a motor. After turning the stator, I have poured ice water on the stator instead of the battery in order to decrease the motion of electrons on the windings of the stator. The rotor turned very slowly then the rotation increased as the sink electricity generated is transmitted to the windings of the stator. Then after it turned I connected the rotor winding to a resistance and dipped that resistance in water. After half an hour I got very cold water. For computers, switches will work for sure, as long as they work for ordinary computers. An advanced technology is needed to implement these concepts.

1. I claim the right for the design, production and sales of floppies, cd's, tv's, stereos, radios, music equipments (speakers, etc. . . . ), tv's and radio stations, broadcasting, all communication equipments, ordinary phones (stations and distribution)cells, all electrical and electronic equipments, all applications and accessories of computers (laptops, desktops, calculators, software, hardware, programs, etc. . . . ), and all devices that receives related to sink electricity and which applies.
